(19) United States
(12) Patent Application Publication
(10) Pub. No.: US 2026/0217234 A1
(43) Pub. Date: Jul. 30, 2026

(54) ACTUATOR MODULE AND MANUFACTURING METHOD FOR AN ACTUATOR MODULE

(71) Applicant: Robert Bosch GmbH, Stuttgart (DE)

(72) Inventors: Ralf Kleemann, Benningen Am Neckar (DE); Bernd Hienz, Baindt (DE); Tobias Loss, Ludwigsburg (DE)

(21) Appl. No.: 19/434,460

(22) Filed: Dec. 29, 2025

(30) Foreign Application Priority Data
Jan. 27, 2025 (DE) 10 2025 102 726.9

(51) Int. Cl. B60T 13/74; B60T 8/44

(52) U.S. Cl. CPC B60T 13/745; B60T 8/44

(57) ABSTRACT

An actuator module. The actuator module includes a first electric motor and a coupling element coupled to the first electric motor in such a way that the coupling element is adjustable, using a first motor force of the first electric motor that is greater than a restoring force of an elastic component of the actuator module, from a starting position in an adjustment direction. The coupling element is coupled to a second electric motor of the actuator module in such a way that the coupling element is adjustable, using a second motor force of the second electric motor greater than the restoring force, from the starting position in the adjustment direction. If the restoring force is greater than the sum of the first motor force and the second motor force, the coupling element is adjustable to the starting position using the restoring force and/or retainable in the starting position.

### FIELD

The present disclosure relates to an actuator module. Furthermore, the present disclosure relates to a manufacturing method for an actuator module.

### BACKGROUND INFORMATION

Germany Patent Application No. DE 10 2021 131 327 A1 describes a braking system that can be referred to as an actuator module and that has an electric motor, the motor force of which acts on at least one braking system component of the braking system.

Further examples of actuators are described in Germany Patent Application Nos. DE 10 2018 211 298 A1, DE 10 2018 219 378 A1 and DE 10 2019 217 023 A1.

### SUMMARY

The present disclosure provides an actuator module, and a manufacturing method for an actuator module.

The present disclosure provides advantageous actuator modules that have good redundancy both because they are equipped with the first electric motor and the second electric motor and because of the mechanical coupling, described further below, of the first electric motor and the second electric motor to the common coupling element. The risk of a sudden failure of the redundant actuator module according to the present disclosure is negligible, since even a total failure of one of its two electric motors can be reliably compensated by means of the other electric motor. As will become clear from the description below, the redundant actuator modules according to the present disclosure can be manufactured at a comparatively low cost. Furthermore, the redundant actuator modules realized by means of the present disclosure are suitable for a plurality of uses, in particular for a driver-assistance function or for an autonomous function in a vehicle/motor vehicle.

In an advantageous example embodiment of the actuator module, the coupling element is coupled to the first electric motor and to the second electric motor in such a way that the coupling element is adjustable, by means of the first electric motor and/or the second electric motor, exclusively in the adjustment direction, while a pulse transmission, directed opposite to the adjustment direction, from the first electric motor or the second electric motor to the coupling element is prevented. Thus, neither the first electric motor nor the second electric motor has a mechanical coupling to the coupling element that allows the coupling element to be retracted to its starting position by means of the first/second electric motor. This simplifies the structural implementation of the actuator module design described here and facilitates its control.

For example, the coupling element can be part of a hydraulic piston-cylinder device of the actuator module and, if the sum of the first motor force and the second motor force is greater than the restoring force, a particular variable volume of at least one hydraulic chamber of the hydraulic piston-cylinder device can be reducible by means of the coupling element adjusted in the adjustment direction. The embodiment of the actuator module described here can therefore advantageously be used to effect a brake pressure build-up in at least one wheel brake cylinder of a vehicle/motor vehicle connected to the actuator module/its hydraulic piston-cylinder device, in particular for autonomous braking of the vehicle/motor vehicle.

Optionally, the first electric motor and/or the second electric motor can be mechanically connected to the coupling element in a push-only manner. Alternatively, the first electric motor and/or the second electric motor can also be mechanically fixedly connected to the coupling element. Thus, there are a plurality of possible embodiments for realizing the advantageous mechanical coupling of the first electric motor and the second electric motor to the common coupling element.

In an advantageous example embodiment of the actuator module, if the sum of the first motor force and the second motor force is greater than the restoring force, a particular brake pressure in at least one wheel brake cylinder connected to the actuator module is increasable by means of the actuator module designed as a hydraulic brake pressure build-up device. The high level of redundancy of the actuator module can therefore advantageously be used to ensure good driving comfort and a high safety standard in the vehicle/motor vehicle equipped with the at least one wheel brake cylinder.

Advantageously, the actuator module can be a hydraulic vehicle braking system, a hydraulic vehicle axle brake module, or a hydraulic vehicle wheel brake module. As will become clear from the description below, there is a high degree of design freedom in the design of the actuator module as a brake module that can be used in a vehicle/motor vehicle to slow it down/brake it.

Furthermore, carrying out a corresponding method for manufacturing an actuator module also provides the advantages described above. It is expressly pointed out that the manufacturing method can be developed in accordance with the embodiments of the actuator module explained above.

### BRIEF DESCRIPTION OF THE DRAWINGS

Further features and advantages of the present disclosure will be explained in the following with reference to the figures.

FIG. 1 is a schematic representation of a first example embodiment of the actuator module.

FIG. 2 is a schematic representation of a second example embodiment of the actuator module.

FIG. 3 is a schematic representation of a third example embodiment of the actuator module.

FIG. 4 is a schematic representation of a fourth example embodiment of the actuator module.

FIG. 5 is a flow chart explaining an example embodiment of the manufacturing method for an actuator module.

### DETAILED DESCRIPTION OF EXAMPLE EMBODIMENTS

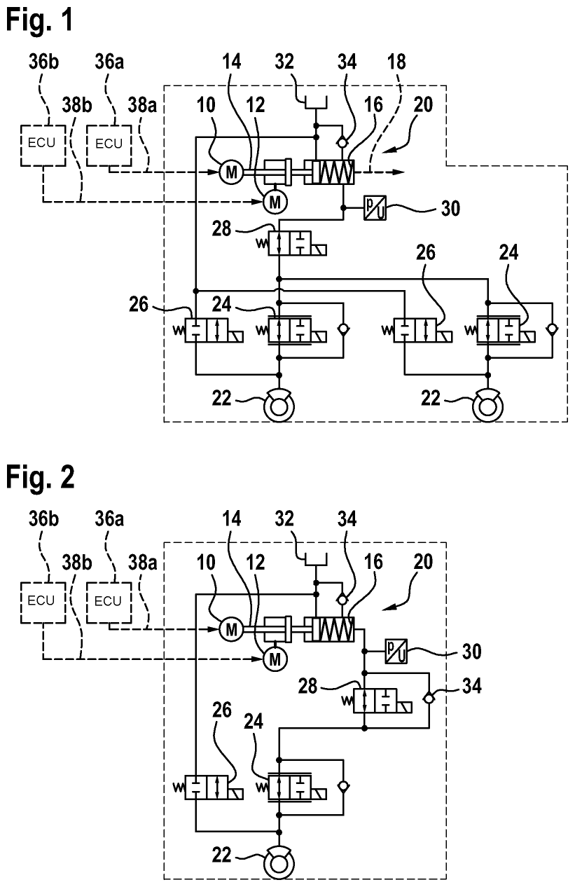

FIG. 1 is a schematic representation of a first embodiment of the actuator module.

The actuator module shown schematically in FIG. 1 has a first electric motor 10, a second electric motor 12 and a coupling element 14. The first electric motor 10 and the second electric motor 12 are understood to be independently operable motors. Accordingly, during operation of the first electric motor 10, the second electric motor 12 can optionally be in a deactivated mode or (also) be put into operation. Correspondingly, during operation of the second electric motor 12, the first electric motor 10 can optionally be in a deactivated mode or (also) be put into operation. It should be noted that the first electric motor 10 and the second electric motor 12 are not to be understood as any particular motor type.

The first electric motor 10 is coupled to the coupling element 14 in such a way that, if a first motor force of the first electric motor 10 is greater than a restoring force of at least one elastic component 16 of the actuator module, the coupling element 14 is adjustable/adjusted, by means of the first motor force, from a starting position in an adjustment direction 18. In addition, the coupling element 14 is coupled to the second electric motor 12 in such a way that, if a second motor force of the second electric motor 12 is greater than the restoring force, the coupling element 14 is adjustable/adjusted, by means of the second motor force, from the starting position in the adjustment direction 18. The first electric motor 10 and/or the second electric motor 12 can be mechanically connected, via at least one gear unit, to the (common) coupling element 14. The first/second motor force can thus be understood to be a force that is transmissible/transmitted, via the at least one gear unit, from the operated first/second electric motor 10 or 12 to the coupling element 14. However, the coupling element 14 is “supported” in its starting position by means of at least one elastic component 16 in such a way that, if the restoring force is greater than the sum of the first motor force and the second motor force, the coupling element 14 is adjustable/adjusted to the starting position by means of the restoring force and/or is retainable/retained in the starting position. Preferably, the restoring force exerted on the coupling element 14 by means of the at least one elastic component 16 is sufficiently high to cause the coupling element 14 to return to its starting position, provided that no motor force of the first electric motor 10 or the second electric motor 12 counteracts it. The at least one elastic component 16 of the actuator module can, in particular, be at least one spring 16, such as specifically at least one return spring 16.

The actuator module is thus characterized by (at least) its electric motors 10 and 12 as two separately and independently operable motor-gear components, which are combined into a complete system by the coupling element 14 in such a way that, even in the event of a complete failure of one of the electric motors 10 or 12, it is possible to optionally maintain, reduce or increase the effect of the actuator module. The actuator module thus has a sufficiently high level of redundancy, so that even when the actuator module is used for safety-critical applications, such as on a vehicle/motor vehicle, (substantially) no failure of the actuator module is to be feared. Nevertheless, as the following description makes clear, the actuator module can be manufactured with relatively little effort and at a comparatively low cost.

Preferably, the coupling element 14 is coupled to the first electric motor 10 and to the second electric motor 12 in such a way that the coupling element 14 can be adjusted, by means of the first electric motor 10 and/or the second electric motor 12, exclusively in the adjustment direction 18. Preferably, a pulse transmission, directed opposite to the adjustment direction 18, from the first electric motor 10 or the second electric motor 12 to the coupling element 14 is thus prevented/precluded. This can also be paraphrased by stating that: there is no mechanical coupling between the electric motors 10 and 12 and the coupling element 14 for retracting the coupling element 14 in a direction opposite to the adjustment direction 18. The at least one gear unit, via which the electric motors 10 and 12 are connected to the coupling element 14, is therefore preferably at least one non-self-locking gear unit. The at least one gear unit of the actuator module can therefore be designed to be comparatively inexpensive. Accordingly, coupling the first electric motor 10 and the second electric motor 12 via the at least one gear unit, in each case to the coupling element 14, is also feasible without significant effort.

The (common) coupling element 14 can be, for example, a plate and/or a piston. In particular, the coupling element 14 can be part of a hydraulic piston-cylinder device 20 of the actuator module. If the sum of the first motor force and the second motor force is greater than the restoring force, in this case a particular variable volume of at least one hydraulic chamber of the hydraulic piston-cylinder device 20 is reducible/reduced by means of the coupling element 14 adjusted in the adjustment direction 18. In this case, the actuator module can therefore advantageously be used for to build up pressure in at least one pressure-to-force converter device 22, in particular of a vehicle/motor vehicle. In the embodiment of FIG. 1 described here, the actuator module serves to cause a pressure build-up in at least one wheel brake cylinder 22 of a vehicle/motor vehicle as the at least one pressure-to-force converter device 22. The actuator module described here can therefore advantageously be used to slow down/brake the particular vehicle/motor vehicle. However, it should be noted that the use of the actuator module described here is also advantageous in other areas of application where a high level of redundancy is desired. In particular, the actuator module described here can also be used as at least part of a wheel-individual or central drive system of a vehicle/motor vehicle and/or as at least part of a wheel-individual or central steering system of a vehicle/motor vehicle, in particular as at least part of a wheel-individual or central brake, drive and/or steering system of a vehicle/motor vehicle.

If, in the redundant actuator module of FIG. 1, the coupling element 14 is adjusted in the adjustment direction 18, which occurs if the sum of the first motor force and the second motor force is greater than the restoring force, the volume of the at least one hydraulic chamber of the hydraulic piston-cylinder device 20 is reduced. By reducing the size of the at least one hydraulic chamber of the hydraulic piston-cylinder device 20, brake fluid from the actuator module designed as a hydraulic brake pressure build-up device is transferred to the at least one wheel brake cylinder 22 connected to the actuator module, thereby increasing the particular brake pressure in the at least one wheel brake cylinder 22. In this way, the braking action of the at least one wheel brake cylinder 22 is increasable so that at least one associated wheel of the vehicle/motor vehicle equipped with the redundant actuator module is braked. If, on the other hand, the sum of the first motor force and the second motor force equals the restoring force, the coupling element 14 is retained in its particular position, which triggers a constant braking action of the at least one wheel brake cylinder 22. However, as soon as the sum of the first motor force and the second motor force is less than the restoring force, the coupling element 14 is adjusted in the direction of its starting position and the braking action of the at least one wheel brake cylinder 22 decreases.

The actuator module shown schematically in FIG. 1 is a hydraulic vehicle axle brake module, i.e., a hydraulic axle brake module, by means of the two wheel brake cylinders 22 of which two wheels of the same axle of the vehicle/motor vehicle equipped therewith can be braked. The particular axle can optionally be a front or a rear axle of the particular vehicle/motor vehicle.

The hydraulic vehicle axle brake module can, for example, have one wheel inlet valve 24 per wheel brake cylinder 22, one wheel outlet valve 26 per wheel brake cylinder 22, a separating valve 28 via which the wheel inlet valves 24 are connected to the hydraulic piston-cylinder device 20, a pressure sensor 30 connected to the hydraulic piston-cylinder device 20, a reservoir 32 into which brake fluid from the wheel brake cylinders 22 is drainable via the wheel outlet valves 26, and/or a check valve 34 via which brake fluid from the reservoir 32 can be drawn/sniffed into the hydraulic piston-cylinder device 20. The electrically controllable components 10, 12, 24, 26 and 28 of the hydraulic vehicle axle brake module can be controllable/controlled by means of at least one electronic control unit (ECU) 36a and 36b. Preferably, the first electric motor 10 is controlled by means of at least one first motor control signal 38a of a first electronic control unit 36a and the second electric motor 12 is controlled by means of at least one second motor control signal 38b of a second electronic control unit 36. By using two electronic control units 36a and 36b for the hydraulic vehicle axle brake module, it can be ensured that a failure of one of the two electronic control units 36a or 36b can be bridged at least temporarily.

As can be seen from FIG. 1, in the hydraulic vehicle axle brake module, wheel-individual brake pressure modulation is possible in each of its wheel brake cylinders 22. If there is too little brake fluid in the hydraulic piston-cylinder device 20, brake fluid can be pushed in from the reservoir 32 via the check valve 34 when the separating valve 28 is closed. Damage caused by leakage at one of the two wheel brake cylinders 22 can be minimized by closing the associated wheel inlet valve 24.

FIG. 2 is a schematic representation of a second embodiment of the actuator module.

The actuator module shown schematically in FIG. 2 is a hydraulic vehicle wheel brake module to which only a single wheel brake cylinder 22 is assigned. Due to its single wheel brake cylinder 22, the hydraulic vehicle wheel brake module has only three valves 24, 26 and 28. Furthermore, another check valve 34 is arranged parallel to the separating valve 28.

The hydraulic vehicle wheel brake module of FIG. 2 can (also) be used to implement a decentralized wheel-individual braking system architecture. The wheel assigned to each wheel brake cylinder 22 can optionally be a front wheel or a rear wheel of the particular vehicle/motor vehicle.

With respect to further features and properties of the actuator module of FIG. 2 and its advantages, reference is made to the description above of FIG. 1.

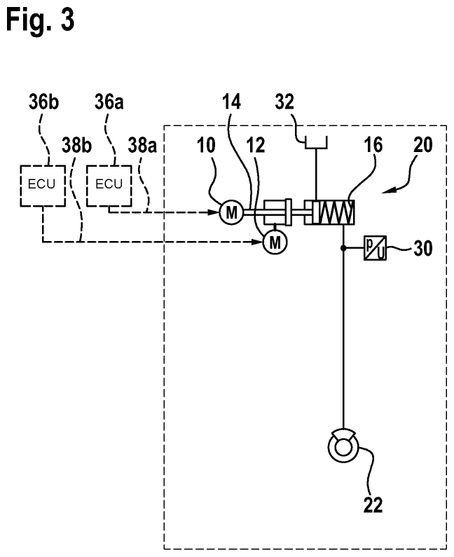

FIG. 3 is a schematic representation of a third embodiment of the actuator module.

In contrast to the embodiment of FIG. 2 described above, the hydraulic vehicle wheel brake module of FIG. 3 dispenses with electrically controllable valves. It can also be seen from FIG. 3 that the check valve 34 can be dispensed with. The actuator module of FIG. 3 is therefore relatively inexpensive to manufacture and requires only a significantly small installation volume.

With respect to further features and properties of the actuator module of FIG. 3 and its advantages, reference is made to the description of FIGS. 1 and 2.

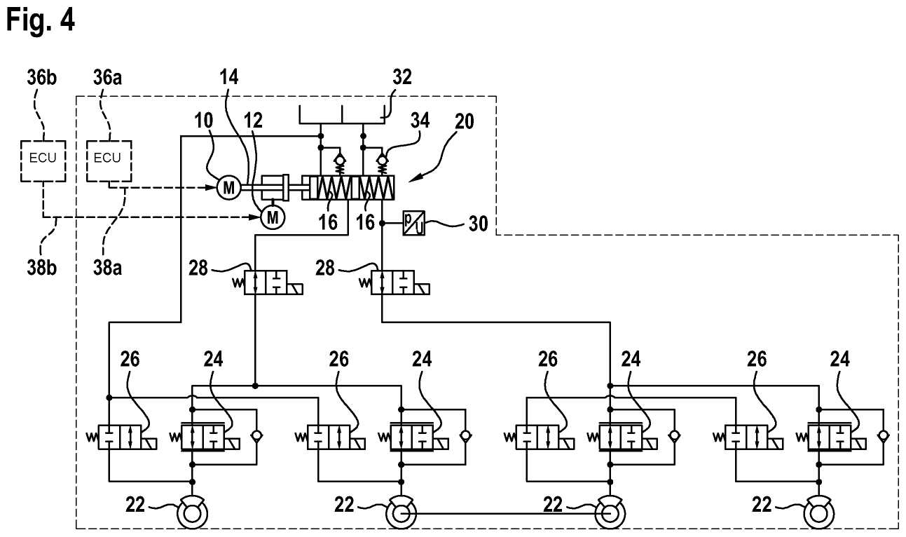

FIG. 4 is a schematic representation of a fourth embodiment of the actuator module.

The actuator module of FIG. 4 is a hydraulic vehicle braking system. The actuator module of FIG. 4 can also be described as a central redundant braking system. The hydraulic vehicle braking system has two brake circuits, each of which is connected to its hydraulic piston-cylinder device 20 via a separating valve 28. Each of the two brake circuits is equipped with two wheel brake cylinders 22, one wheel inlet valve 24 per wheel brake cylinder 22 and one wheel outlet valve 26 per wheel brake cylinder 22. Optionally, each brake circuit can also be connected to its “own” hydraulic chamber of the hydraulic piston-cylinder device 20, wherein, in particular, each of the two hydraulic chambers can also be connected to the reservoir 32 via its “own” check valve 34.

With respect to further features and properties of the actuator module of FIG. 4 and its advantages, reference is made to the description of FIG. 1 to 3.

In all of the actuator modules described above, its two electric motors 10 and 12 can optionally be used together or alternatively/alternatingly to trigger the particular braking action of the wheel brake cylinders 22. In particular, so-called “hot redundancy” can be implemented in all of the actuator modules described above, by using both electric motors 10 and 12 simultaneously to produce a desired braking action of the wheel brake cylinders 22. The advantage here is that a sudden failure of one of the two electric motors 10 or 12 can optionally be compensated more quickly by operating the other electric motor 10 or 12 that is already (also) activated. Furthermore, monitoring to detect errors may not be necessary. Alternatively, however, typically (only) one of the electric motors 10 or 12 can be used as the master motor, while the other electric motor 10 or 12 is only used as the replacement motor after the master motor fails.

In each of the actuator modules described above, the first electric motor 10 and/or the second electric motor 12 can be mechanically connected to the coupling element 14 in a “push” only manner. Alternatively, the first electric motor 10 and/or the second electric motor 12 can also be mechanically fixedly connected to the coupling element 14.

In all the above-described embodiments of the actuator module, its power-consuming components are preferably electrically connected to two redundant on-board electrical systems of the particular vehicle/motor vehicle equipped therewith. In the event of a failure of one of the two on-board electrical systems of the vehicle/motor vehicle, sufficient functionality of the particular actuator module may still be ensured.

The above-described design of the actuator modules as brake pressure build-up devices, or as at least part of a wheel-individual or central braking system of a vehicle/motor vehicle, is to be interpreted merely by way of example. In particular, such an actuator module can also be used as at least part of a wheel-individual or central drive system of a vehicle/motor vehicle and/or as at least part of a wheel-individual or central steering system of a vehicle/motor vehicle, in particular as at least part of a wheel-individual or central brake, drive and/or steering system of a vehicle/motor vehicle.

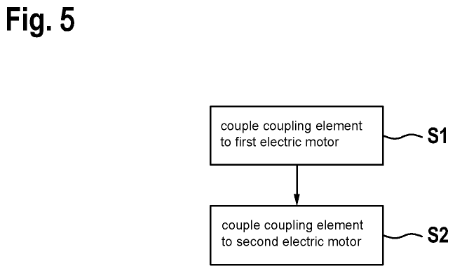

FIG. 5 is a flow chart explaining an embodiment of the manufacturing method for an actuator module.

All of the actuator modules described above can be manufactured by means of the manufacturing method described below. However, it is pointed out that the feasibility of the manufacturing method described below is not limited to producing such an actuator module.

In a method step S1 of the manufacturing method, a coupling element is coupled to a first electric motor of the actuator module in such a way that the coupling element is adjusted, by means of a first motor force of the first electric motor that is greater than a restoring force of at least one elastic component of the actuator module, from a starting position in an adjustment direction. Furthermore, in a method step S2, the coupling element is additionally coupled to a second electric motor of the actuator module in such a way that the coupling element is adjusted, by means of a second motor force of the second electric motor that is greater than the restoring force, from the starting position in the adjustment direction. The method steps S1 and S2 are carried out in such a way that, if the restoring force is greater than the sum of the first motor force and the second motor force, the coupling element is adjusted to the starting position by means of the restoring force and/or is retained in the starting position. To this end, the coupling element is supported in its starting position by means of at least one elastic component. The method steps S1 and S2 can be carried out in any temporal order, overlapping in time or simultaneously.

1-10. (canceled)

11. An actuator module, comprising:
a first electric motor;
a second electric motor;
at least one elastic component; and
a coupling element that is coupled to the first electric motor in such a way that the coupling element is adjustable, using a first motor force of the first electric motor that is greater than a restoring force of the at least one elastic component of the actuator module, from a starting position in an adjustment direction;
wherein the coupling element is additionally coupled to the second electric motor of the actuator module in such a way that the coupling element is adjustable, using a second motor force of the second electric motor that is greater than the restoring force, from the starting position in the adjustment direction, and when the restoring force is greater than a sum of the first motor force and the second motor force, the coupling element is: (i) adjustable to the starting position using the restoring force and/or (ii) retainable in the starting position.

12. The actuator module according to claim 11, wherein the coupling element is coupled to the first electric motor and to the second electric motor in such a way that the coupling element is adjustable, using the first electric motor and/or the second electric motor, exclusively in the adjustment direction, while a pulse transmission, directed opposite to the adjustment direction, from the first electric motor or the second electric motor to the coupling element is prevented.

13. The actuator module according to claim 11, wherein the coupling element is part of a hydraulic piston-cylinder device of the actuator module, and when the sum of the first motor force and the second motor force is greater than the restoring force, a variable volume of at least one hydraulic chamber of the hydraulic piston-cylinder device is reducible using the coupling element adjusted in the adjustment direction.

14. The actuator module according to claim 11, wherein the first electric motor and/or the second electric motor are mechanically connected to the coupling element in a push-only manner.

15. The actuator module according to claim 11, wherein the first electric motor and/or the second electric motor are mechanically fixedly connected to the coupling element.

16. The actuator module according to claim 11, wherein, when the sum of the first motor force and the second motor force is greater than the restoring force, a brake pressure in at least one wheel brake cylinder connected to the actuator module is increasable using the actuator module configured as a hydraulic brake pressure build-up device.

17. The actuator module according to claim 11, wherein the actuator module is a hydraulic vehicle braking system.

18. The actuator module according to claim 11, wherein the actuator module is a hydraulic vehicle axle brake module.

19. The actuator module according to claim 11, wherein the actuator module is a hydraulic vehicle wheel brake module.

20. A manufacturing method for an actuator module, the method comprising:
coupling a coupling element to a first electric motor of the actuator module in such a way that the coupling element is adjusted, using a first motor force of the first electric motor that is greater than a restoring force of at least one elastic component of the actuator module, from a starting position in an adjustment direction;
wherein the coupling element is additionally coupled to a second electric motor of the actuator module in such a way that the coupling element is adjusted, using a second motor force of the second electric motor that is greater than the restoring force, from the starting position in the adjustment direction, and when the restoring force is greater than a sum of the first motor force and the second motor force, the coupling element is: (i) adjusted to the starting position using the restoring force and/or (ii) retained in the starting position.
